(19) United States
(12) Patent Application Publication
(10) Pub. No.: US 2017/0297142 A1
(43) Pub. Date: Oct. 19, 2017

(54) FRICTION STIR WELDING METHOD

(71) Applicant: IHI Corporation, Tokyo (JP)

(72) Inventors: Hiroshi SAITO, Tokyo (JP); Kunitaka MASAKI, Tokyo (JP); Koji NEZAKI, Tokyo (JP); Tadafumi KANAYAMA, Tokyo (JP); Satoshi YAMANAKA, Tokyo (JP); Yasushi TABEI, Tokyo (JP)

(73) Assignee: IHI Corporation, Tokyo (JP)

(21) Appl. No.: 15/642,013

(22) Filed: Jul. 5, 2017

Related U.S. Application Data
(63) Continuation of application No. PCT/JP2016/050090, filed on Jan. 5, 2016.

(30) Foreign Application Priority Data
Jan. 9, 2015 (JP) 2015-003000

(51) Int. Cl. B23K 20/12

(52) U.S. Cl. CPC B23K 20/1255; B23K 20/128

(57) ABSTRACT

The present disclosure arranges a pair of friction stir welding tools including probes and fixed shoulders at corner portions between a first workpiece and a second workpiece. The friction stir welding tools are arranged so that regions where the probes are embedded in the respective the corner portions and stirred are positioned symmetrically with respect to the second workpiece. With this arrangement of the friction stir welding tools, the corner portions are friction stir welded simultaneously.

### CROSS-REFERENCE TO RELATED APPLICATION

This application is a Continuous Application based on International Application No. PCT/JP2016/050090, filed Jan. 5, 2016, which claims priority to Japanese Patent Application No. 2015-003000, filed Jan. 9, 2015, the contents of which are incorporated herein by reference.

### TECHNICAL FIELD

The present disclosure relates to a friction stir welding method used for welding corner portions of workpieces.

### BACKGROUND ART

As a friction stir welding tool (a tool for friction stir welding) used in the case of performing friction stir welding, a type having a rotary shoulder which integrally rotates with a probe and a type having a rotating probe and a non-rotating fixed shoulder are known.

Regarding a friction stir welding tool including a fixed shoulder, a type in which the fixed shoulder has a surface which comes into contact with both of workpiece surfaces of corner portions such that the corner portions (inner corner portions) of the workpieces to be welded are friction stir welded is known.

Further, there is an existing proposal for a method in which two corner portions foil led by abutting a horizontal workpiece (a horizontal member) and a workpiece (a standing member) erected thereon are friction stir welded from both sides of the erected workpiece using two friction stir welding tools for welding the corner portions as described above (see, for example, Patent Document 1).

In this friction stir welding method, the tools for friction stir welding (the friction stir welding tools) disposed on both sides of the erected workpiece have a constitution in which positions of the stirring shafts (probes) in a direction of progress of friction stir welding are shifted, and thus defects in the welding due to collision between the stirring shafts and mutual interference between stirring regions are prevented.

Also, a method called AdStir in which, when the friction stir welding of a corner portion is performed by a friction stir welding tool including a fixed shoulder, a welding filler is added so that R (a fillet by overlaying) is formed at the corner portion after the welding has been also conventionally proposed (see, for example, Non-Patent Document 1).

### [Patent Document 1]

Japanese Unexamined Patent Application, First Publication No. 2013-166159

### [Non-Patent Document 1]

Tetsuo Fukuda, Takao Kakubari “TWI's latest FSW process development status and patent information”, Welding technology, SANPO Publications, Inc., June 2011, Volume 59, No. 6, p. 57-60

### SUMMARY

### Technical Problem

However, in the friction stir welding method disclosed in Patent Document 1, the positions of the stirring shafts of the friction stir welding tools disposed at both sides of the erected workpiece are shifted in a direction of progress of friction stir welding. Therefore, when the stirring shafts are embedded in each of the corner portions at the time of starting the friction stir welding, a rotational moment is generated in a horizontal plane with respect to each of the workpieces and a means for holding each of the workpieces.

Furthermore, Non-Patent Document 1 done not specifically disclose an idea of preventing the rotational moment generated in the workpieces when the friction stir welding is performed.

Therefore, the present disclosure provides a friction stir welding method in which, when friction stir welding on two corner portions between workpieces is performed using a pair of friction stir welding tools including fixed shoulders, a rotational moment in a plane along one workpiece is prevented from being generated in each of the workpieces.

### Solution to Problem

A first embodiment of the present disclosure provides a friction stir welding method which welds both of corner portions formed by a first workpiece and a second workpiece of which an edge is abutted thereto in an angle posture intersecting with a surface of the first workpiece, wherein one pair of friction stir welding tools including probes which are embedded in both of the corner portions by rotation driving thereof and fixed shoulders which are arranged on outer circumferences of base end sides of the probes to be in contact with surfaces of the two workpieces forming each of the corner portions are arranged at both of the corner portions between which the second workpiece is interposed, so that regions in which each of the probes is embedded in each of the corner portions and is stirred are positioned symmetrically with respect to the second workpiece, and the corner portions are simultaneously friction stir welded by the friction stir welding tools.

### Effects

According to the friction stir welding method of the present disclosure, when friction stir welding on two corner portions between workpieces is performed using a pair of friction stir welding tools including fixed shoulders, a rotational moment in a plane along one workpiece can be prevented from being generated in each of the workpieces.

### BRIEF DESCRIPTION OF DRAWINGS

FIG. 1A illustrates a first embodiment of a friction stir welding method and is a plan view of a portion of corner portions between workpieces in which a friction stir welding is performed.

FIG. 1B shows the first embodiment of the friction stir welding method and is a perspective view in an A-A direction of FIG. 1.

FIG. 2 shows an application example of the first embodiment and is a view illustrating a portion of corner portions between workpieces in which a friction stir welding is performed when seen from one side in a direction of progress of friction stir welding.

FIG. 3 shows a second embodiment of the friction stir welding method and is a view illustrating a portion of a corner portion between workpieces in which a friction stir welding is performed when seen from one side in a friction stir welding proceeding direction.

### DESCRIPTION OF EMBODIMENTS

A friction stir welding method of the present disclosure will be described with reference to the drawings.

### First Embodiment

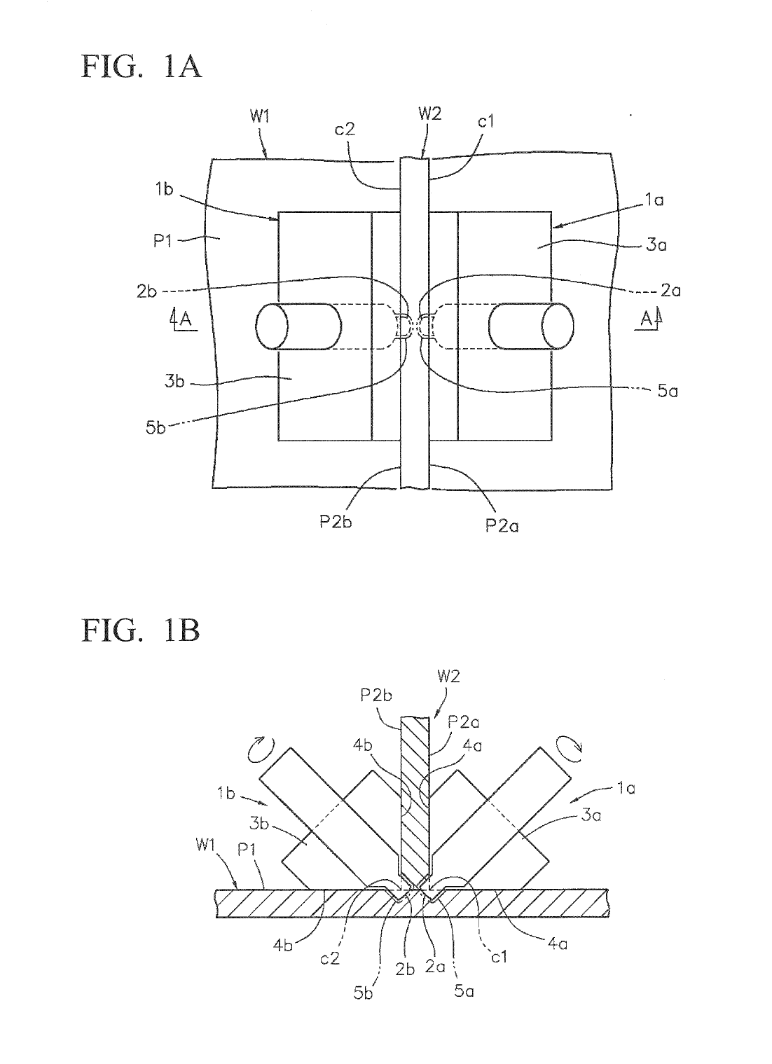

FIGS. 1A and 1B show a first embodiment of a friction stir welding method, FIG. 1A is a plan view illustrating a portion of a corner portion between workpieces in which a friction stir welding is performed, and FIG. 1B is a perspective view in an A-A direction of FIG. 1

As illustrated in FIG. 1B, in a friction stir welding method of the embodiment, two corner portions (inner corner portions) c1 and c2 formed by a first workpiece W1 and a second workpiece W2 abutted against a surface P1 of the first workpiece W1 in an angle posture intersecting therewith are a subject of a friction stir welding. For example, the embodiment describes a case in which the surface P1 of the first workpiece W1 is horizontally disposed and the second workpiece W2 is vertically abutted against the surface P1 of the first workpiece W1 from above. Also, the first workpiece W1 and the second workpiece W2 are held by a workpiece holding means which is not illustrated in the above-described arrangement.

In the friction stir welding method of the embodiment, a first friction stir welding tool 1a disposed at the corner portion c1 on one side surface P2a side of the second workpiece among the two corner portions c1 and c2 and a second friction stir welding tool 1b disposed at the corner portion c2 on the other side surface P2b side are used.

The first friction stir welding tool 1a includes a rotatable probe 2a and a fixed shoulder 3a disposed at an outer circumference on a base end side of the probe 2a. The probe 2a may be disposed in an angle posture in which an axial direction is parallel to a bisector of an angle of the corner portion c1. In the embodiment, since the corner portion c1 has a right angle, the axial direction of the probe 2a is set in an obliquely downward angle posture which is inclined by 45 degrees from a vertical direction along the second workpiece W2 toward one side surface P2a. The fixed shoulder 3a is formed in a chevron shape (a V shape) so that an end disposed close to a front end of the probe 2a has two workpiece contact surfaces 4a, 4b which are in contact with the surface P1 of the first workpiece W1 and the side surface P2a of the second workpiece W2 forming the corner portion c1.

The second friction stir welding tool 1b includes a rotatable probe 2b and a fixed shoulder 3b disposed at an outer circumference on a base end side of the probe 2b. The probe 2b may be disposed in an angle posture in which an axial direction is in parallel with a bisector of an angle of the corner portion c2. In the embodiment, since the corner portion c2 has a right angle, the axial direction of the probe 2b is set in an obliquely downward angle posture which is inclined by 45 degrees from the vertical direction along the second workpiece W2 toward the other side surface P2b. The fixed shoulder 3b is formed in a chevron shape (a V shape) so that an end disposed close to a front end of the probe 2b has two workpiece contact surfaces 4b which are in contact with the surface P1 of the first workpiece W1 and the side surface P2b of the second workpiece W2 framing the corner portion c2.

As illustrated in FIG. 1A, relative positions between the first friction stir welding tool 1a and the second friction stir welding tool 1b are set so that a region 5a in which the probe 2a is embedded in the corner portion c1 and which is stirred and a region 5b in which the probe 2b is embedded in the corner portion c2 and which is stirred are symmetrically positioned with respect to the second workpiece W2. Specifically, the fixed shoulders 3a and 3b and the probes 2a and 2b are arranged at both sides of the second workpiece W2 so that positions thereof are aligned in a friction stir welding proceeding direction.

Also, in the first friction stir welding tool 1a and the second friction stir welding tool 1b, as illustrated in FIGS. 1A and 1B, a protruding amount of each of the probes 2a and 2b from each of the fixed shoulders 3a and 3b is set so that interference between the probes 2a and 2b embedded in the corner portions c1 and c2 and also between the regions 5a and 5b which are respectively stirred by the probes 2a and 2b does not occur when the friction stir welding of the corner portion c1 and the corner portion c2 is simultaneously performed at both of the side surface sides of the second workpiece W2.

Accordingly, in the first workpiece W1 and the second workpiece W2, the friction stir welding of each of the corner portions c1 and c2 by the friction stir welding tools 1a and 1b is performed as a partial stir welding so that the interference between the regions 5a and 5b which are respectively stirred by the probes 2a and 2b does not occur. Therefore, in the first workpiece W1 and the second workpiece W2 after the welding, a contact surface therebetween partially remains between portions welded by stirring in the regions 5a and 5b.

When the friction stir welding method of the embodiment is performed, first, each of the friction stir welding tools 1a and 1b is disposed near a starting position of the friction stir welding in each of the corner portions c1 and c2.

Then, in each of the friction stir welding tools 1a and 1b, a rotation driving of each of the probes 2a and 2b is started, and then the probes 2a and 2b are embedded in each of the corner portions c1 and c2.

At this time, a portion at which a pressing load for embedding the probe 2a in the corner portion c1 acts with respect to each of the workpieces W1 and W2 is the region 5a. Meanwhile, a portion at which a pressing load for embedding the probe 2b in the corner portion c2 acts with respect to each of the workpieces W1 and W2 is the region 5b.

Therefore, in a process in which each of the probes 2a and 2b is embedded in each of the corner portions c1 and c2, the portion of each of the workpieces W1 and W2 on which the pressing load of the probe 2a acts and the portion thereof on which the pressing load of the probe 2b acts are symmetrically positioned with respect to the second workpiece W2, and thus the rotational moment in a horizontal plane along the surface P1 of the first workpiece W1 due to each of the pressing loads is not generated at each of the workpieces W1 and W2.

Next, in the friction stir welding method of the embodiment, when each of the probes 2a and 2b is embedded in each of the corner portions c1 and c2 and each of workpiece contact surfaces 4a and 4b of the fixed shoulders 3a and 3b are in contact with each of the workpieces W1 and W2, relative movement between each of the friction stir welding tools 1a and 1b and each of the workpieces W1 and W2 in a direction along each of the corner portions c1 and c2 is started.

At this time, the relative movement between each of the friction stir welding tools 1a and 1b and each of the workpieces W1 and W2 is performed by one of a method in which each of the friction stir welding tools 1a and 1b moves while each of the workpieces W1 and W2 is fixed and a method in which each of the workpieces W1 and W2 moves with respect to each of the friction stir welding tools 1a and 1b of which a position is fixed.

Accordingly, the friction stir welding is performed at each of the corner portions c1 and c2 in a state in which the regions 5a and 5b which are stirred by the probes 2a and 2b do not interfere with each other. Therefore, the first workpiece W1 and the second workpiece W2 are partially stir welded.

Also while the friction stir welding is performed, the portion of each of the workpieces W1 and W2 on which the pressing load of the probe 2a acts and the portion thereof on which the pressing load of the probe 2b acts are the regions 5a and 5b which are symmetrically positioned with respect to the second workpiece W2. Therefore, the rotational moment in the horizontal plane along the surface P1 of the first workpiece W1 due to each of the pressing loads is not generated at each of the workpieces W1 and W2.

In the friction stir welding method of the embodiment, when each of the probes 2a and 2b arrives at a terminating position of the friction stir welding in each of the corner portions c1 and c2, the relative movement of each of the friction stir welding tools 1a and 1b with respect to each of the corner portions c1 and c2 is stopped. Then, each of the probes 2a and 2b is withdrawn from each of the corner portions c1 and c2, and the rotation thereof is then stopped. The rotational moment which is the same as that described above is not generated with respect to each of the workpieces W1 and W2 by an operation in which each of the probes 2a and 2b is withdrawn from each of the corner portions c1 and c2.

Accordingly, each of the corner portions c1 and c2 is friction stir welded in each of the workpieces W1 and W2.

As described above, according to the friction stir welding method of the embodiment, when the friction stir welding of the two corner portions c1 and c2 between the workpieces W1 and W2 is performed using the pair of friction stir welding tools la and 1b having the fixed shoulders 3a and 3b, the rotational moment in the horizontal plane along the surface P1 of the first workpiece W1 can be prevented from being generated in each of the workpieces W1 and W2.

Therefore, the workpiece holding means which is not illustrated and holds each of the workpieces W1 and W2 when the friction stir welding is performed is not particularly required to have a rigidity or strength for fixing the positions of the workpieces W1 and W2 to oppose the rotational moment as described above. Therefore, it is possible to simplify a structure of the workpiece holding means.

Further, in the above-described arrangement of each of the friction stir welding tools 1a and 1b, since a horizontal component of the pressing load of the probe 2a along the surface P1 of the first workpiece W1 and a horizontal component of the pressing load of the probe 2b are opposed to each other, a horizontal force which acts on the workpiece holding means which is not illustrated and holds each of the workpieces W1 and W2 can be reduced.

Furthermore, in each of the friction stir welding tools 1a and 1b, the protruding amount of each of the probes 2a and 2b from each of the fixed shoulders 3a and 3b is set such that partial stir welding is performed. Therefore, the friction stir welding of the corner portions c1 and c2 can be simultaneously performed from both surface sides of the second workpiece W2.

Also, in the friction stir welding method of the embodiment, an insertion amount of each of the probes 2a and 2b into each of the corner portions c1 and c2 can be reduced compared with in a case in which full stir welding which is generally conventionally performed for friction stir welding of the corner portions and in which the regions stirred by the probes disposed at the corner portions interfere with each other is performed.

As a result, a reaction force applied to each of the probes 2a and 2b when each of the probes 2a and 2b moves in a state of being embedded in each of the corner portions c1 and c2 can be smaller than that applied to each of the probes in the entire stir welding. Therefore, not only a speed of the friction stir welding but also a lifespan of each of the friction stir welding tools 1a and 1b can be increased in the friction stir welding method of the embodiment compared with that in a case in which the entire stir welding is performed.

Further, in the friction stir welding method of the embodiment, a heat amount which is locally input to each of the regions 5a and 5b in which each of the workpieces W1 and W2 is stirred due to frictional heat generated from each of the probes 2a and 2b is reduced compared with that in the case in which the entire stir welding is performed. Therefore, occurrence of a distortion or a deformation in the each of the workpieces W1 and W2 due to heat can be minimized.

Furthermore, in the friction stir welding method of the embodiment, since the friction stir welding of each of the corner portions c1 and c2 is simultaneously performed from both of the side surface sides of the second workpiece W2, one point on each of the workpieces W1 and W2 in the friction stir welding proceeding direction is heated by the frictional heat generated from each of the probes 2a and 2b. Therefore, the friction stir welding method of the embodiment can heat each of the workpieces W1 and W2 more effectively than in the case in which each of the corner portions c1 and c2 is heated by the frictional heat generated from each of the probes disposed at other positions in the friction stir welding proceeding direction. Accordingly, the friction stir welding method of the embodiment can promote stabilization of the friction stir welding by high heat input in the friction stir welding of the corner portion c1 and the corner portion c2.

In addition, since the regions 5a and 5b stirred by each of the probes 2a and 2b is easily softened as the heating efficiency of each of the workpieces W1 and W2 is enhanced as described above, the friction stir welding method of the embodiment can increase the speed of the friction stir welding. Also, since resistance when each of the probes 2a and 2b is rotationally driven is reduced, each of the friction stir welding tools 1a and 1b can have a long lifespan.

Also, in the case in which the corner portion c1 and the corner portion c2 are heated by the frictional heat generated from the probes disposed at other positions in an X axis direction, one of the corner portion c1 and the corner portion c2 is first heated and the other is heated later, and thus conditions of the heat input may not be equalized. However, the friction stir welding method of the embodiment can promote equalization of the heat input in each of the corner portions c1 and c2.

Also, in the friction stir welding method of the embodiment, the fixed shoulders 3a and 3b of the friction stir welding tools 1a and 1b are directly arranged at each of the corner portions c1 and c2. Therefore, for example, when the friction stir welding of the corner portions is performed using a friction stir welding tool including a rotary shoulder, a preliminary processing such as disposing a member having a triangular cross section at the corner portion, or providing a protruding portion having the triangular cross section at the corner portion of one workpiece is required. However, such preliminary processing is not required in the friction stir welding method of the embodiment.

### Application Example of the First Embodiment

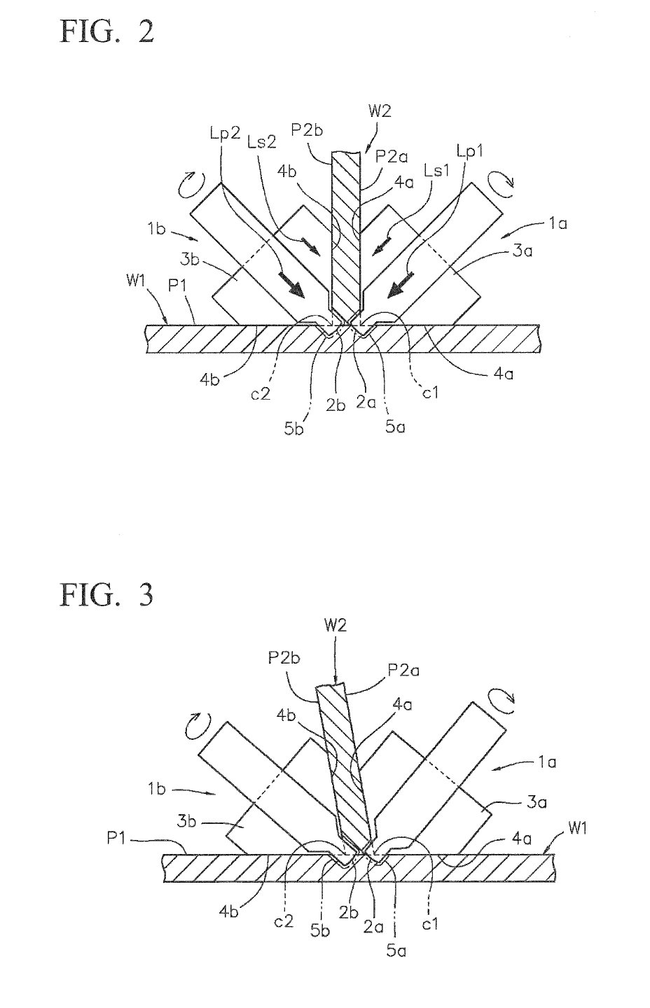

FIG. 2 illustrates an application example of the first embodiment and is a view illustrating a portion of a corner portion of workpieces in which the friction stir welding is performed when seen from one side in the friction stir welding proceeding direction.

Also, in FIG. 2, elements the same as those in FIGS. 1A and 1B are designated by the same reference numerals, and descriptions thereof will be omitted.

The fixed shoulders 3a and 3b in the friction stir welding tools 1a and 1b move along the corner portions c1 and c2 as the friction stir welding progresses. At this time, each of the fixed shoulders 3a and 3b slides with respect to each of the workpieces W1 and W2. Accordingly, the load when each of the fixed shoulders 3a and 3b is pressed against the corner portions c1 and c2 may be substantially constant.

Therefore, in the application example, loads Ls1 and Ls2 when each of the fixed shoulders 3a and 3b is pressed against the corner portions c1 and c2 are controlled separately from pressing loads Lp1 and Lp2 of the probes 2a and 2b.

The pressing loads Lp1 and Lp2 which act on each of the probes 2a and 2b may be appropriately controlled so that the heat amount required for each of the regions 5a and 5b in each of the corner portions c1 and c2 is generated by the frictional heat of each of the probes 2a and 2b. Also, the pressing loads Lp1 and Lp2 which act on each of the probes 2a and 2b may be controlled so that a torque required for the rotation driving of each of the probes 2a and 2b is a value within a preset range.

Meanwhile, the loads Ls1 and Ls2 which act on each of the fixed shoulders 3a and 3b may be controlled such that they have values within a separately preset range.

Other constitutions are the same as those in FIGS. 1A and 1B, and the same elements are designated by the same reference numerals.

Even when the loads Ls1 and Ls2 which act on each of the fixed shoulders 3a and 3b are controlled separately from the pressing loads Lp1 and Lp2 which act on each of the probes 2a and 2b as described in the application example, use is possible as in the first embodiment, and thus the same effects as that in the first embodiment can be obtained, for example, the rotational moment in the horizontal plane does not occur at each of the workpieces W1 and W2 when the friction stir welding is performed.

On the other hand, when a method in which a load acting on the fixed shoulders is controlled separately from a pressing load acting on each of stirring shafts (probes) as described above is applied to, for example, Patent Document 1, the pressing load is applied from each of the stirring shafts to another position on the workpiece in the friction stir welding proceeding direction when the friction stir welding is performed. Therefore, in the case of Patent Document 1, the rotational moment in the horizontal plane occurs at the workpiece. However, in the application example, the occurrence of the rotational moment can be prevented.

### Second Embodiment

FIG. 3 shows a second embodiment of the friction stir welding method and is a view illustrating a portion of a corner portion between workpieces in which a friction stir welding is performed when seen from one side in a friction stir welding proceeding direction.

Also, in FIG. 3, elements the same as those in FIGS. 1A and 1B are designated by the same reference numerals, and descriptions thereof will be omitted.

In a friction stir welding method of the embodiment, two corner portions (inner corner portions) c1 and c2 formed by a first workpiece W1 and a second workpiece W2 abutted against a surface P1 of the first workpiece W1 in an angle posture other than 90 degrees are a subject of a friction stir welding. For example, the embodiment describes a case in which the surface P1 of the first workpiece W1 is disposed along a horizontal plane and the second workpiece is abutted against the surface P1 of the first workpiece W1 from above in an angle posture which is inclined at a predetermined angle from a vertical surface toward a side surface P2b thereof. Therefore, one corner portion c1 has an obtuse angle, and the other corner portion c2 has an acute angle.

Friction stir welding tools 1a and 1b used in the friction stir welding method of the embodiment have the same constitution as that in the first embodiment except that a fixed shoulder 3a of the first friction stir welding tool 1a disposed at the corner portion cl has a chevron-shaped obtuse end formed by the surface P1 of the first workpiece W1 and the side surface P2a of the second workpiece W2.

The probe 2a of the first friction stir welding tool 1a is disposed in an angle posture in which an axial direction is in parallel with a bisector of an angle of the corner portion c1.

Also, the fixed shoulder 3b of the second friction stir welding tool 1b disposed at the corner portion c2 is formed to have a chevron-shaped acute end formed by the surface P1 of the first workpiece W1 and a side surface P2b of the second workpiece W2.

The probe 2b of the second friction stir welding tool 1b is disposed in an angle posture in which an axial direction is in parallel with a bisector of an angle of the corner portion c2.

Other constitutions are the same as those illustrated in FIGS. 1A and 1B, and the same elements are designated by the same reference numerals.

According to the friction stir welding method of the embodiment, the friction stir welding of the two corner portions c1 and c2 between the first workpiece W1 and the second workpiece W2 abutted in an angle posture other than 90 degrees can be performed in the same manner as that in the first embodiment.

At this time, when the friction stir welding is performed, the same effects as in the first embodiment can be obtained, for example, the rotational moment in the horizontal plane does not occur at each of the workpieces W1 and W2.

Also, the present disclosure is not limited to each of the embodiments and the application example, and in each of the friction stir welding tools 1a and 1b, the axial direction of each of the probes 2a and 2b may not necessarily coincide with a direction of the bisector of the angle of each of the corner portions c1 and c2 which are the subject of the friction stir welding.

In each of the friction stir welding tools 1a and 1b, the axial direction of each of the probes 2a and 2b may be inclined in the friction stir welding proceeding direction.

In each of the fixed shoulders 3a and 3b, as long as each of the workpiece contact surfaces 4a and 4b which is in contact with the surfaces of each of the workpieces W1 and W2 located at both sides of the corner portions c1 and c2 as the welding subjects is formed to have a chevron shape, other portions thereof may have shapes other than the illustrated shapes.

A plane on which the surface P1 of the first workpiece W1 is disposed may not be a horizontal plane and may be inclined. In this case, the angle posture of each of the friction stir welding tools 1a and 1b may be set according to each of the corner portions c1 and c2.

When the friction stir welding is performed, the method called AdStir disclosed in Non-Patent Document 1 may be used.

In this case, each of the friction stir welding tools 1a and 1b has the same constitution as illustrated in FIGS. 1A and 1B or 2, except that a cutout portion in which a welding filler is inserted is provided at a front side of a chevron-shaped top portion formed by the workpiece contact surfaces 4a and 4b of each of the fixed shoulder 3a and 3b in the friction stir welding proceeding direction and a cutout portion having a shape corresponding to a fillet desired to be formed at each of the corner portions c1 and c2 after the welding is provided at a rear side thereof in the friction stir welding proceeding direction.

Of course, various modifications can be made within the scope not deviating from the gist of the present disclosure.

### INDUSTRIAL APPLICABILITY

According to the present disclosure, the rotational moment due to the pressing load of the friction stir welding tools can be prevented from occurring at the workpieces.

1. A friction stir welding method which welds both of corner portions formed by a first workpiece and a second workpiece of which an edge is abutted thereto in an angle posture intersecting with a surface of the first workpiece,
wherein one pair of friction stir welding tools including probes which are embedded in both of the corner portions by rotation driving thereof and fixed shoulders which are arranged on outer circumferences of base end sides of the probes to be in contact with surfaces of the two workpieces forming each of the corner portions are arranged at both of the corner portions between which the second workpiece is interposed, so that regions in which each of the probes is embedded in each of the corner portions and is stirred are positioned symmetrically with respect to the second workpiece, and the corner portions are simultaneously friction stir welded by the friction stir welding tools.

2. The friction stir welding method according to claim 1,
wherein each of the friction stir welding tools is arranged so that the regions in which each of the probes is embedded in each of the corner portions and is stirred do not interfere with each other.
